(19) United States
(12) Patent Application Publication
(10) Pub. No.: US 2006/0013970 A1
(43) Pub. Date: Jan. 19, 2006

(54) Method for providing a layer, wiring substrate, elector-optical device, and electronic equipment

(75) Inventor: Kenji Wada, Fujimi-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/146,136

(22) Filed: Jun. 7, 2005

(30) Foreign Application Priority Data
Jul. 14, 2004 (JP) 2004-207177

(51) Int. Cl. B05D 5/12; B41M 5/00

(52) U.S. Cl. 428/32.24; 427/96.1; 427/256

(57) ABSTRACT

A method for providing a layer by ink jetting, comprising: (a) discharging a first liquid insulating material of a first concentration on a surface of a first level so that a side of a first conductive layer placed on the surface is covered by the first insulating material; (b) providing a first insulating layer facing the first conductive layer by one of activating and drying the first insulating material that has been discharged; (c) discharging a second liquid insulating material of a second concentration on the first conductive layer and the first insulating layer, the second concentration being higher than the first concentration; and (d) providing a second insulating layer covering the first conductive layer and the first insulating layer by one of activating and drying the second insulating material that has been discharged.

### BACKGROUND

The present invention relates to a method for providing a layer, wiring substrate, electro-optical device and electronic equipment.

A method for manufacturing a wiring substrate using an additive process of printing has drawn attention. This is because the additive process requires fewer costs than another method for manufacturing a wiring substrate involving repetitive processes of thin-film application and photolithography.

Techniques for providing a metal wiring by ink jetting applicable to this additive process have been developed. Japanese Unexamined Patent Publication No. 2004-6578 is an example of related art.

To form a pattern of a film or layer on a substance by ink jetting, the degree of spread of a discharged material on the substance must be made different from one part to another, in some cases, depending on the shape of the pattern. For example, it is preferably that a material that has landed on a substance does not spread very much to form a layer boundary. This way the layer boundary can be clearly defined. For another example, a material that has landed on a substance may spread when forming an inner portion of the same layer.

Forming an insulating layer having a contact hole, for example, requires a liquid material of a comparatively high concentration. This is because such a material takes a comparatively short time to lose its liquidity due to the vaporization of its solvent after being discharged, and thus it is easy to define the outer shape of an opening serving as the contact hole.

However, such a liquid material does not spread broadly after it has landed. Therefore, it is difficult for such a liquid material to provide a layer with a flat surface that eliminates an underlying step.

### SUMMARY

An advantage of the present invention is to provide an insulating layer with a flat surface that eliminates an underlying step and having a contact hole by ink jetting.

A method for providing a layer according to an aspect of the invention is used for manufacturing a wiring substrate by ink jetting. The method includes:
(a) discharging a first liquid insulating material of a first concentration on a surface of a first level so that a side of a first conductive layer placed on the surface is covered by the first insulating material;
(b) providing a first insulating layer facing the first conductive layer by activating or drying the first insulating material that has been discharged;
(c) discharging a second liquid insulating material of a second concentration on the first conductive layer and the first insulating layer, the second concentration being higher than the first concentration; and
(d) providing a second insulating layer covering the first conductive layer and the first insulating layer by activating or drying the second insulating material that has been discharged.

This method makes it easy to provide the flat insulating layer covering the first conductive layer by ink jetting.

It is preferable that the first conductive layer is a copper wiring.

In this case, it is possible to provide the insulating layer on a widely available wiring substrate by ink jetting.

It is preferable that the method for providing a layer also includes:
(e) discharging a first liquid conductive material on the surface; and
(f) providing the first conductive layer by activating or drying the first conductive material that has been discharged.

This method makes it possible to apply ink jetting to providing the conductive layer.

It is more preferable that (e) includes discharging the first conductive material containing silver.

This method makes it easy to provide the conductive layer by ink jetting.

It is preferable that (c) includes discharging the second insulating material so that the second insulating material defines a contact hole that exposes part of the first conductive layer, and (d) includes providing the second insulating layer having the contact hole by activating or drying the second insulating material that has been discharged.

This method makes it possible to providing the insulating layer having the contact hole by ink jetting.

It is preferable that the method for providing a layer also includes:
(g) providing a second conductive layer facing the first conductive layer in the contact hole.

It is preferable that (g) includes discharging a second liquid conductive material in the contact hole, and providing the second conductive layer by activating or drying the second conductive material that has been discharged.

This method makes it possible to providing the conductive layer filling up the contact hole by ink jetting.

A method for providing a layer according to another aspect of the invention is used for providing a layer that covers a first part and a second part facing the first part by ink jetting. The method includes:
(a) discharging a first liquid insulating material of a first concentration on the first part; and
(b) discharging a second liquid insulating material of a second concentration on the second part after (a).

This method makes it possible to make the degree of spread of the liquid materials partly different on a substance. Therefore, it is easy to provide layer boundary and inner parts.

A wiring substrate according to yet another aspect of the invention is manufactured by any of the above-described methods for providing a layer.

Accordingly, the wiring substrate is manufactured by ink jetting.

An electro-optical device according to a further aspect of the invention is manufactured by any of the above-described methods for providing a layer.

Accordingly, the electro-optical device is manufactured by ink jetting.

Electronic equipment according to a still further aspect of the invention is manufactured by any of the above-described methods for providing a layer.

Accordingly, the electronic equipment is manufactured by ink jetting.

### BRIEF DESCRIPTION OF THE DRAWINGS

The invention will be described with reference to the accompanying drawings, wherein like numbers refer to like elements, and wherein:

FIG. 1 is a schematic of a layer-deposition unit;

FIG. 2 is a schematic of a discharge device included in the layer-deposition unit;

FIGS. 3A and 3B are schematics of a head included in the discharge device;

FIG. 4 is a functional block diagram of a controller included in the discharge device;

FIGS. 5A through 5D illustrate a manufacturing method according to a first embodiment of the invention;

FIGS. 6A through 6E illustrate the manufacturing method according to the first embodiment of the invention;

FIGS. 7A through 7D illustrate the manufacturing method according to the first embodiment of the invention;

FIGS. 8A through 8E illustrate a manufacturing method according to a second embodiment of the invention;

FIG. 9 is a schematic of a mobile phone; and

FIG. 10 is a schematic of a personal computer.

### DETAILED DESCRIPTION OF EMBODIMENTS

### First Embodiment

A wiring substrate according to a first embodiment of the invention is made with a tape-like base substrate. Here the base substrate is made of polyimide and also called a flexible substrate. On the base substrate, a metal wiring is provided by a manufacturing process that will be described in detail later. After the metal wiring is provided, the base substrate is pressed to cut out a plurality of substrates. Thus, a plurality of substrates each of which is provided with a metal wiring are made out of the base substrate. According to the present embodiment, every metal wiring provided to the plurality of substrates has the same pattern. The substrate provided with the metal wiring is referred to as a “wiring substrate”.

A. Layer-Deposition Unit

The wiring substrate according to the present embodiment is manufactured by a layer-deposition process performed with six layer-deposition units. These six layer-deposition units have fundamentally the same structure and function. Therefore, the structure and function of one representative unit out of the six layer-deposition units will be described below to prevent redundancy.

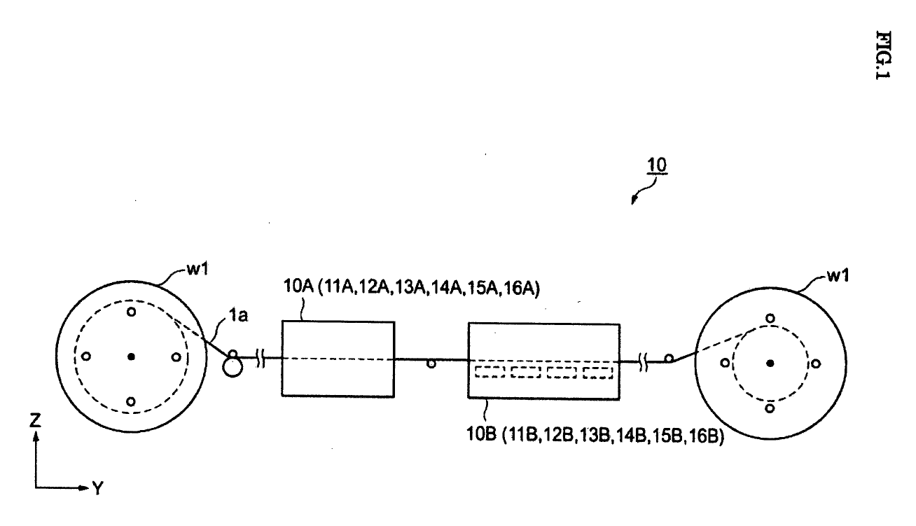

A layer-deposition unit 10 shown in FIG. 1 is a unit for providing a conductive or insulating layer on a surface placed at a certain level. The layer-deposition unit 10 includes a pair of reels W1, a discharge device 10A, and an oven 10B. The discharge device 10A and the oven 10B included in the layer-deposition unit 10 process a base substrate 1a while the base substrate 1a is reeled out from one of the reels W1 and then reeled in to the other of the reels W1. This processing is also called “reel-to-reel”.

The discharge device 10A discharges a liquid material onto a surface placed at a certain level of the base substrate 1a. The oven 10B heats and activates the liquid material supplied or applied by the discharge device 10A.

Six discharge devices (each corresponding to the discharge device 10A) included in six layer-deposition units (each corresponding to the layer-deposition unit 10) are hereinafter referred to as follows for the sake of convenience: a first discharge device 11A, a second discharge device 12A, a third discharge device 13A, a fourth discharge device 14A, a fifth discharge device 15A, and a sixth discharge device 16A. In the same manner, six ovens (each corresponding to the oven 10B) are hereinafter referred to as follows for the sake of convenience: a first oven 11B, a second oven 12B, a third oven 13B, a fourth oven 14B, a fifth oven 15B, and a sixth oven 16B.

The six discharge devices 11A, 12A, 13A, 14A, 15A, and 16A have fundamentally the same structure and function. Therefore, the structure and function of the first discharge device 11A will be described below to prevent redundancy as a representative of the six discharge devices 11A, 12A, 13A, 14A, 15A, and 16A.

B. Structure of the Discharge Device

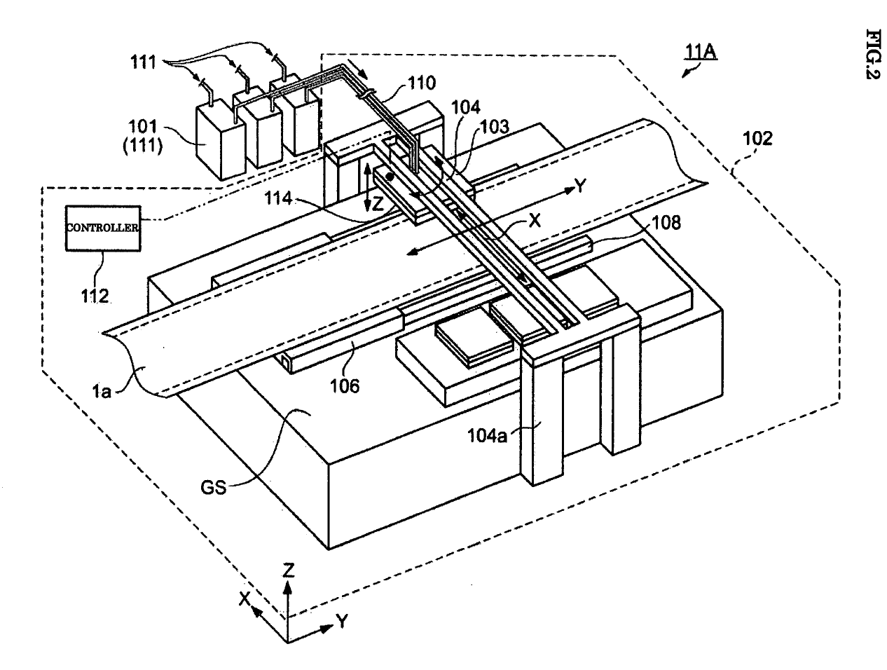

The first discharge device 11A shown in FIG. 2 is an inkjet device. The first discharge device 11A includes a tank 101 for storing a liquid material 111, a tube 110, and a discharge scanner 102 for supplying the liquid material 111 from the tank 101 through the tube 110. The discharge scanner 102 includes a ground stage GS, a discharge head 103, a stage 106, a first position controller 104, a second position controller 108, a controller 112, and a support 104a.

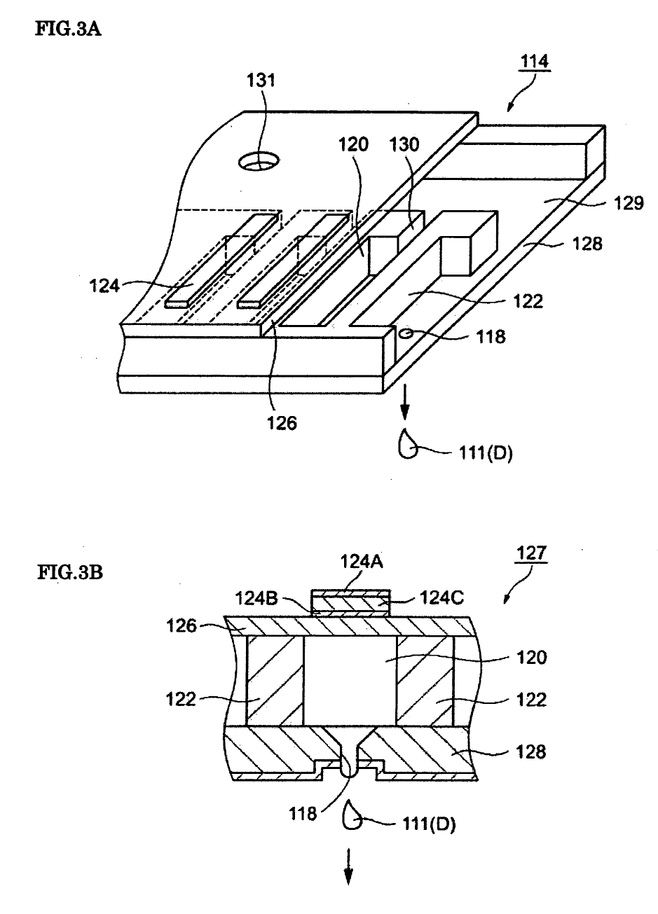

The discharge head 103 holds a head 114 shown in FIG. 3. The head 114 discharges droplets of the liquid material 111 based on a signal from the controller 112. The head 114 held by the discharge head 103 is coupled to the tank 101 by the tube 110. Accordingly, the liquid material 111 is supplied from the tank 101 to the head 114.

The stage 106 provides a flat surface for fixing the base substrate 1a. The stage 106 also fixes the position of the base substrate 1a by suction.

The first position controller 104 is fixed by the support 104a at a certain height from the ground stage GS. The first position controller 104 moves the discharge head 103 in the X-axis direction and the Z-axis direction perpendicular thereto, based on a signal from the controller 112. Furthermore, the first position controller 104 rotates the discharge head 103 around an axis parallel to the Z axis. In the present embodiment, the Z-axis direction is parallel to the vertical direction (i.e., the direction of gravitational acceleration).

The second position controller 108 moves the stage 106 on the ground stage GS in the Y-axis direction based on a signal from the controller 112. Here, the Y-axis direction is perpendicular to the X-axis and Z-axis directions.

The structures of the first position controller 104 and the second position controller 108 are available by using a known XY robot employing a linear motor or servomotor. Here, a detailed description thereof is omitted. The first position controller 104 and the second position controller 108 are hereinafter also referred to as “robot” or “scanner”.

As described above, the first position controller 104 moves the discharge head 103 in the X-axis direction. In addition, the second position controller 108 moves the base substrate 1a together with the stage 106 in the Y-axis direction. As a result, the relative position of the head 114 to the base substrate 1a changes. Specifically, the discharge head 103, the head 114 or a nozzle 118 (shown in FIG. 3) moves, in other words scans, in the X-axis and Y-axis directions relatively to the base substrate 1a while maintaining a certain distance therefrom in the Z-axis direction. Moving or scanning relatively refers to moving at least one of one side discharging the liquid material 111 relatively to the other side (recipient) onto which the discharged material has landed.

The controller 112 receives discharge data (e.g. bitmap data) representing a relative position to which the liquid material 111 should be discharged from an external information processor. The controller 112 stores the discharge data it has received in an internal memory, and controls, based on the stored discharge data, the first position controller 104, the second position controller 108, and the head 114.

The first discharge device 11A having the above-described structure moves the nozzle 118 (shown in FIG. 3) of the head 114 relatively to the base substrate 1a based on bitmap data, and discharges the liquid material 111 from the nozzle 118 onto a recipient. The bitmap data are used for providing a material on the base substrate 1a with a predetermined pattern. Note that the relative movement of the head 114 and discharging of the liquid material 111 from the head 114 in the first discharge device 11A may be collectively referred to as “application scan” or “discharge device”.

Here, the recipient means an area onto which droplets of the liquid material 111 land and spread. Furthermore, the recipient is formed by surface modification of an underlying substance, so that the liquid material 111 will be discharged with a desired angle of contact. Here, if the surface of an underlying substance is preferably lyophobic or lyophilic to the liquid material 111 without such surface modification (i.e. the liquid material 111 has landed on the surface of the underlying substance with a desired angle of contact), the surface of the underlying substance may serve as the recipient. The recipient is hereinafter also referred to as “target” or “receptive part”.

C. Head

As shown in FIGS. 3A and 3B, the head 114 included in the first discharge device 11A is an inkjet head having a plurality of nozzles 118. The head 114 includes an oscillating plate 126 and a nozzle plate 128 that defines the opening of each nozzle 118. Provided between the oscillating plate 126 and the nozzle plate 128 is a reservoir 129. The reservoir 129 is always filled with the liquid material 111 supplied from an external tank (not shown) through a hole 131.

Also provided between the oscillating plate 126 and the nozzle plate 128 are a plurality of partition walls 122. An area surrounded by the oscillating plate 126, the nozzle plate 128, and a pair of partition walls 122 is a cavity 120. Provided correspondingly to the nozzles 118, cavities 120 are provided in the same number as the nozzles 118. The liquid material 111 is supplied from the reservoir 129 to each of the cavities 120 through a supply opening 130 placed between a pair of partition walls 122. The diameter of each nozzle 118 is approximately 27 μm in the present embodiment.

On the oscillating plate 126, oscillators 124 are provided correspondingly to the cavities 120. Each of the oscillators 124 includes a piezoelectric element 124C and a pair of electrodes 124A and 124B that sandwich the piezoelectric element 124C. The controller 112 provides a driving voltage in between the pair of electrodes 124A and 124B, making droplets D of the liquid material 111 be discharged from a correspondent nozzle 118. Here, the volume of the material discharged from the nozzle 118 is variable from 0 to 42 picoliters. The shape of the nozzle 118 is adjusted, so that droplets D of the liquid material 111 are discharged from the nozzle 118 in the Z-axis direction.

A portion including one nozzle 118, a cavity 120 corresponding to the nozzle 118, and an oscillator 124 corresponding to the cavity 120 is hereinafter also referred to as “discharge portion 127”. Accordingly, one head 114 includes the same number of nozzles 118 and discharge portions 127. The discharge portion 127 may include an electrothermal converting element instead of the piezoelectric element. In other words, the discharge portion 127 may have a structure for discharging a material by means of the thermal expansion of the material with the electrothermal converting element.

D. Controller

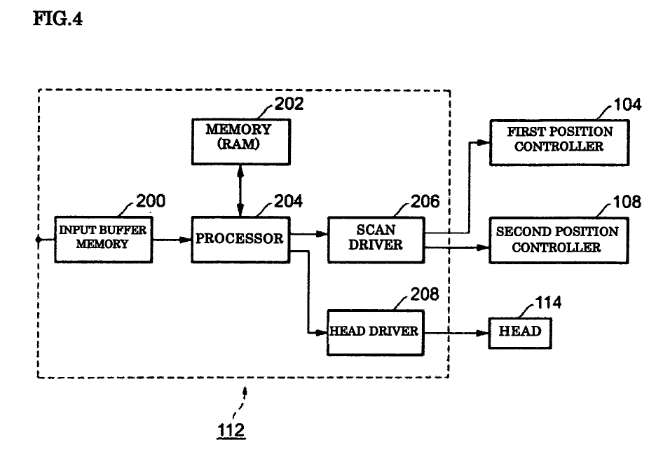

The structure of the controller 112 will now be described. As shown in FIG. 4, the controller 112 includes an input buffer memory 200, a memory 202, a processor 204, a scan driver 206, and a head driver 208. The input buffer memory 200 and the processor 204 are coupled, so that they can communicate to each other. The processor 204 and the memory 202 are coupled, so that they can communicate to each other. Also, the processor 204 and the scan driver 206 are coupled, so that they can communicate to each other. Furthermore, the processor 204 and the head driver 208 are coupled, so that they can communicate to each other. The scan driver 206 is coupled to the first position controller 104 and the second position controller 108, so that they can communicate to each other. In the same manner, the head driver 208 is coupled to the head 114, so that they can communicate to each other.

The input buffer memory 200 receives discharge data for discharging droplets D of the liquid material 111 from a host computer (not shown) outside the first discharge device 11A. The input buffer memory 200 provides the processor 204 with the discharge data. The processor 204 then stores the discharge data in the memory 202. In the example shown in FIG. 4, the memory 202 is a random access memory (RAM).

The processor 204 provides the scan driver 206 with data showing the relative position of the nozzle 118 to a recipient base on the discharge data in the memory 202. The scan driver 206 provides the second position controller 108 with a stage drive signal based on the data and the cycle of discharge. As a result, the head 114 moves relatively to the recipient. Meanwhile, the processor 204 provides, base on the discharge data stored in the memory 202, the head 114 with a discharge signal required for discharging the liquid material 111. Consequently, a corresponding nozzle 118 in the head 114 discharges droplets D of the liquid material 111.

The controller 112 may be a computer provided with a central processing unit (CPU), read only memory (ROM), random access memory (RAM), and bus. In this case, the above-described function of the controller 112 is provided by a software program that is executed by a computer. Alternatively, the controller 112 may be provided by an exclusive circuit (hardware).

E. Liquid Material

The liquid material 111 means a viscid material that can be discharged as droplets from the nozzle 118 of the head 114. The liquid material 111 can be either a water- or oil-based material. It is sufficient to have a certain fluidity (viscosity) with which the material can be discharged from the nozzle 118. The material can even contain a solid matter as long as it is fluid as a whole.

The viscosity of the liquid material 111 is preferably from 1 to 50 mPa·s. A viscosity of 1 mpa·s or more prevents an area around the nozzle 118 from being contaminated by the outflow of the liquid material 111 while discharging droplets D of the liquid material 111. Meanwhile, a viscosity of 50 mPa·s or less reduces the possibility of clogging of the nozzle 118, and provides smooth droplet discharge.

First, second, and third conductive materials that will be described later are examples of the liquid material 111. The first conductive material is discharged from the first discharge device 11A, the second conductive material from the fourth discharge device 14A, and the third conductive material from the fifth discharge device 15A.

In the present embodiment, the first, second, and third conductive materials include silver particles whose average diameter is about 10 nm, a dispersion medium, and an organic solvent. The silver particles are covered by the dispersion medium in these conductive materials. The silver particles covered by the dispersion medium are stably dispersed in the organic solvent. Here, the dispersion medium is a compound that is capable of being coordinated with silver atoms. Examples of such a dispersion medium include amine, alcohol, and thiol.

Particles whose average diameter is about 1 to several hundred nanometers are also called nanoparticles. Accordingly, the first, second, and third conductive materials include silver nanoparticles.

Furthermore, first, second, and third insulating materials that will be described later are also examples of the liquid material 111. The first insulating material is discharged from the second discharge device 12A, while the second insulating material is discharged from the third discharge device 13A. The third insulating material is discharged from the sixth discharge device 16A. Here, the first and third insulating materials are identical.

In the present embodiment, the first and second insulating materials are solutions including a polyimide precursor and N-methyl-2-pyrrolidone that is a solvent (diluent). In both the first and second insulating materials, the concentration of the polyimide precursor is set at predetermined values. In the present embodiment, the concentration of the polyimide precursor contained in the first insulating material is lower than that in the second insulating material. In general, the higher the concentration of a polyimide precursor is, the shorter it takes for the first and second insulating materials to substantially lose their fluidity. Meanwhile, the lower the concentration of the polyimide precursor is, the longer the first and second insulating materials can maintain their fluidity.

The concentration of the polyimide precursors contained in the first and second insulating materials corresponds to the concentration of an insulating material according to the present invention. If an insulating layer is provided by agglomerating insulating particles instead of polymerization, the concentration or weight percent of such insulating particles corresponds to the concentration of an insulating material according to the invention.

F. Manufacturing Method

A method for providing, that is, manufacturing a layer will now be described.

A first conductive layer 21 is provided on almost the same level of the base substrate 1a.

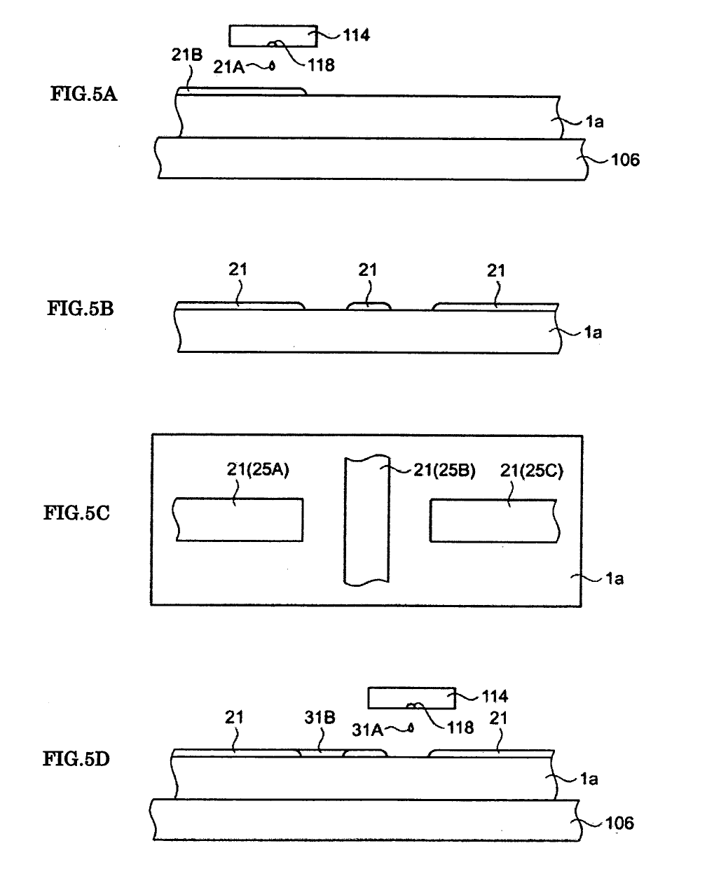

First, the base substrate 1a is placed on the stage 106 included in the first discharge device 11A as shown in FIG. 5A. Consequently, the first discharge device 11A provides, based on first bitmap data, a first conductive material layer 21B on a recipient on the base substrate 1a.

More specifically, the relative position of the nozzle 118 to the base substrate 1a is changed two dimensionally, i.e. in the X-axis and Y-axis directions. When the nozzle 118 reaches at a position corresponding to a pattern to be formed, the first discharge device 11A discharges droplets of a first conductive material 21A from the nozzle 118. The discharged droplets of the first conductive material 21A land on a recipient on the base substrate 1a. As the droplets of the first conductive material 21A land on the recipient, the first conductive material layer 21B is provided on the recipient on the base substrate 1a.

The first bitmap data are a kind of discharge data. The discharge data include information representing a relative position (discharge position) on which droplets are to be discharged from the nozzle 118 and information representing the volume of the droplets to be discharged onto each discharge position. The discharge data are supplied from an external information processor or host computer (not shown) to a memory in the controller 112 included in the first discharge device 1A. The controller 112 controls, based on the provided discharge data, moving of the head 114 by the first position controller 104 and discharge of droplets by the head 114.

After providing the first conductive material layer 21B, the first conductive material layer 21B is activated. For this purpose, the base substrate 1a is placed inside the first oven 1B in the present embodiment. By heating the first conductive material layer 21B, silver micro particles in the first conductive material layer 21B are sintered or welded. As a result of the activation, a first conductive layer 21 having a first pattern is provided on the base substrate 1a as shown in FIG. 5B.

The first conductive layer 21 having the first pattern includes a wiring 25A, a wiring 25B, and a wiring 25C as shown in FIG. 5C. The wirings 25A, 25B, and 25C are laid out on recipients on the base substrate 1a. This means that the wirings 25A, 25B, and 25C are positioned on a surface L1 on almost the same level. The wirings 25A, 25B, and 25C are physically separated from each other on the surface L1. The wirings 25A and 25B are electrically coupled to each other in a later step. Meanwhile, the wiring 25C is electrically isolated from both of the wirings 25A and 25B.

F2. First Insulating Layer

As the first conductive layer 21 having the first pattern is provided, a step is developed to the thickness of the first conductive layer 21 on the base substrate 1a. Therefore, a first insulating layer 31 is provided on part of the base substrate 1a in which the first conductive layer 21 has not been provided as shown in FIG. 5D in the present embodiment. The first insulating layer 31 covers the side of the first conductive layer 21, and thereby eliminating the step accompanying the first conductive layer 21.

First, the base substrate 1a provided with the first conductive layer 21 is placed on the stage 106 included in the second discharge device 12A as shown in FIG. 5D. Consequently, the second discharge device 12A provides, based on second bitmap data, a first insulating material layer 31B on a recipient on the base substrate 1a.

More specifically, the relative position of the nozzle 118 to the base substrate 1a is changed two dimensionally. When the nozzle 118 reaches at a position corresponding to the recipient, the second discharge device 12A discharges droplets of a first insulating material 31A from the nozzle 118. The discharged droplets of the first insulating material 31A land on the recipient on the base substrate 1a. As the droplets of the first insulating material 31A land on the recipient, the first insulating material layer 31B is provided on the recipient on the base substrate 1a.

Here, the concentration of the first insulating material 31A is set sufficiently low, so that after the first insulating material 31A has landed it can maintain its fluidity until it spreads to cover the side of the first conductive layer 21. Accordingly, the first insulating material 31A that has landed on the recipient forms a layer (first insulating material layer 31B) to an even thickness on the recipient.

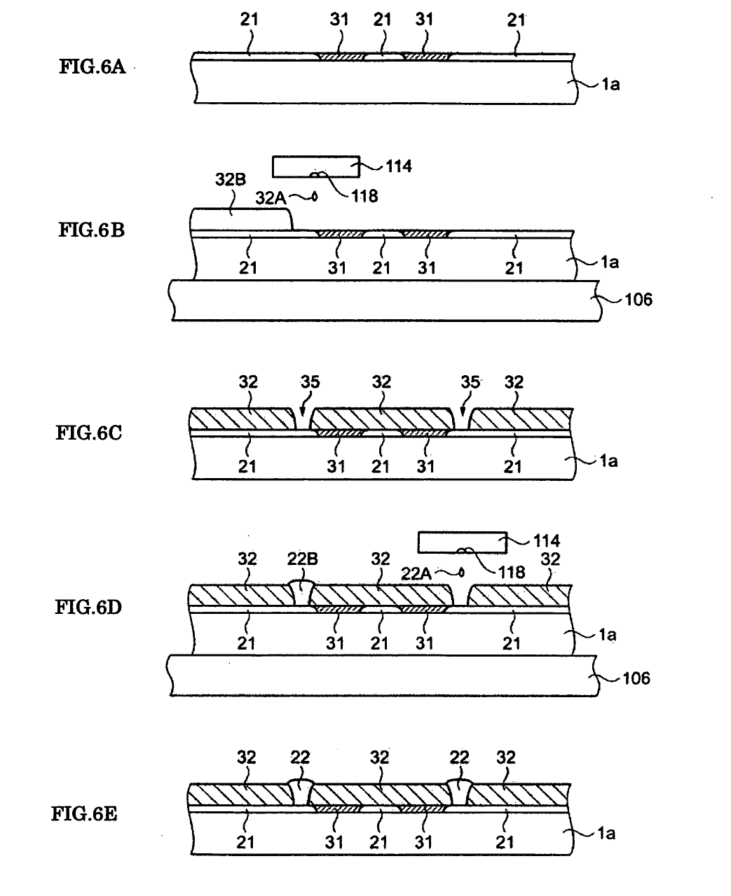

After providing the first insulating material layer 31B, the first insulating material layer 31B is activated. For this purpose, the base substrate 1a is placed inside the second oven 12B in the present embodiment. By heating the first insulating material layer 31B, a polyimide precursor in the first insulating material layer 31B is polymerized to provide a polyimide layer. As a result of the activation, a first insulating layer 31 (polyimide layer) is provided on the base substrate 1a as shown in FIG. 6A.

Providing the first insulating layer 31 eliminates a step developed on the base substrate 1a accompanying the first conductive layer 21. This is because the surface of the first conductive layer 21 and the surface of the first insulating layer 31 are on almost the same level. The surface consisting of the surfaces of the first conductive layer 21 and the first insulating layer 31 is hereinafter also called “second level surface”.

F3. Second Insulating Layer

After providing the first insulating layer 31, a second insulating layer that covers the first conductive layer 21 and the first insulating layer 31 is provided.

As shown in FIG. 6B, the base substrate 1a provided with the first conductive layer 21 and the first insulating layer 31 is placed on the stage 106 included in the third discharge device 13A. Consequently, the third discharge device 13A provides, based on third bitmap data, a second insulating material layer 32B that covers the first conductive layer 21 and the first insulating layer 31.

Specifically, the relative position of the nozzle 118 to the base substrate 1a is changed two dimensionally. When the nozzle 118 reaches at a position corresponding to a recipient on the first conductive layer 21 and a recipient on the first insulating layer 31, the third discharge device 13A discharges droplets of a second insulating material 32A from the nozzle 118. The discharged droplets of the second insulating material 32A land on the recipients on the first conductive layer 21 and the first insulating layer 31. As the droplets of the second insulating material 32A land on the recipients, the second insulating material layer 32B that covers the first conductive layer 21 and the first insulating layer 31 is provided.

Here, the droplets of the second insulating material 32A are discharged in a way that a contact hole 35 is formed on each of the wirings 25A and 25C. In other words, the droplets of the second insulating material 32A are discharged in a way that the outer shape of the contact hole 35 is defined by the second insulating material 32A that has landed. Therefore, the droplets of the second insulating material 32A are not discharged onto an area to be reserved for the contact hole 35.

The concentration of the second insulating material 32A is higher than that of the first insulating material 31A. Accordingly, it takes a shorter time for the second insulating material 32A that has landed on the first conductive layer 21 to lose its fluidity than for the first insulating material 31A to lose its fluidity. As a result, the second insulating material 32A is more suitable for defining the contact hole 35 than the first insulating material 31A. In the present embodiment, an area to be reserved for the contact hole 35 is left as an opening even before the second insulating material layer 32B is activated.

After providing the second insulating material layer 32B, the second insulating material layer 32B is activated. For this purpose, the base substrate 1a is placed inside the third oven 13B in the present embodiment. By heating the second insulating material layer 32B, a polyimide precursor in the second insulating material layer 32B is polymerized to provide a polyimide layer. As a result of the activation, a second insulating layer 32 (polyimide layer) that covers the first conductive layer 21 and the first insulating layer 31 is provided as shown in FIG. 6C. As described above, the second insulating layer 32 has the contact hole 35 on each of the wirings 25A and 25C.

While the concentration of the second insulating material 32A is high, the surface of the second insulating layer 32 made of the second insulating material 32A is flat. This is because the surface of the recipient (second level surface) onto which the second insulating material 32A lands is a flat surface consisting of the first conductive layer 21 and the first insulating layer 31.

The first insulating material 31A and the second insulating material 32A are provided as follows. First, the second insulating material 32A of a concentration suitable for defining the contact hole 35 is provided by adjusting a polyimide precursor concentration in a solution. Then, the first insulating material 31A is provided by adding a certain amount of solvent to the second insulating material 32A to dilute the second insulating material 32A. Here, N-methyl-2-pyrrolidone or N,N-dimethylacetamide may be used as the solvent.

F4. Second Conductive Layer

After the second insulating layer 32 is provided, a second conductive layer is provided to penetrate the contact hole 35 provided to the second insulating layer 32.

First, the base substrate 1a is placed on the stage 106 included in the fourth discharge device 14A as shown in FIG. 6D. Consequently, the fourth discharge device 14A provides, based on fourth bitmap data, a second conductive material layer 22B that penetrates the contact hole 35 provided to the second insulating layer 32.

Specifically, the relative position of the nozzle 118 to the second insulating layer 32 is changed two dimensionally. When the nozzle 118 reaches at a position corresponding to the contact hole 35, the fourth discharge device 14A discharges droplets of a second conductive material 22A from the nozzle 118. The discharged droplets of the second conductive material 22A land on a recipient on the first conductive layer 21 that is exposed by the contact hole 35. As the droplets land and fill up the contact hole 35, the second conductive material layer 22B penetrating the contact hole 35 is provided.

After providing the second conductive material layer 22B, the second conductive material layer 22B is activated. For this purpose, the base substrate 1a is placed inside the fourth oven 14B in the present embodiment. By heating the second conductive material layer 22B, silver micro particles in the second conductive material layer 22B are sintered or welded. As a result of the activation, the wirings 25A and 25C in the first conductive layer 21 are electrically and physically coupled, and a second conductive layer 22 that penetrates the contact hole 35 is provided as shown in FIG. 6E.

F5. Third Conductive Layer

After providing the second conductive layer 22, a third conductive layer 23 is provided on the second insulating layer 32 and the second conductive layer 22.

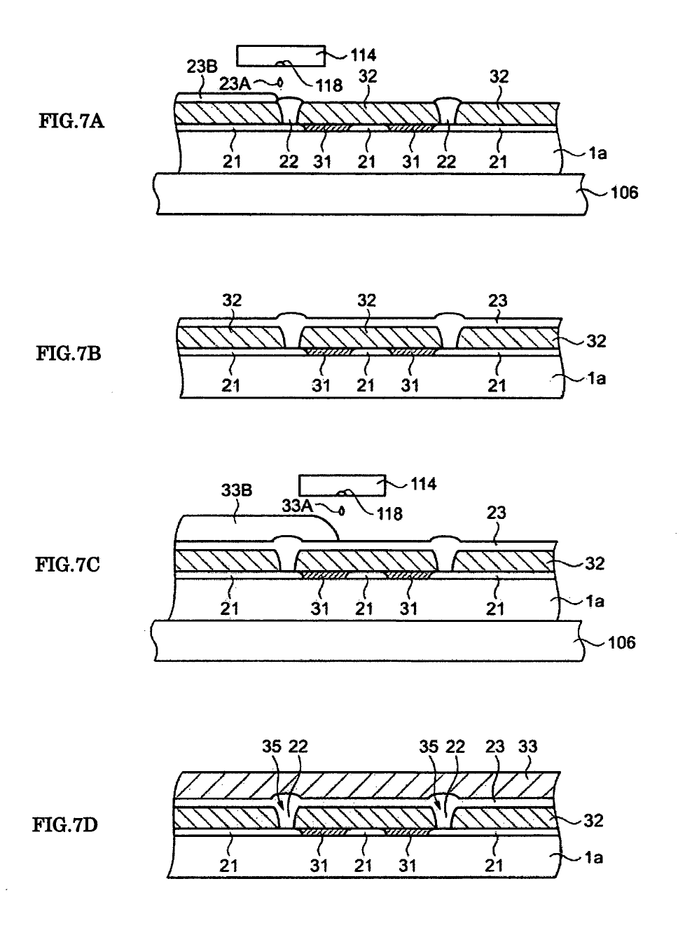

First, the base substrate 1a is placed on the stage 106 included in the fifth discharge device 15A as shown in FIG. 7A. Consequently, the fifth discharge device 15A provides, based on fifth bitmap data, a third conductive material layer 23B with a second pattern on a recipient on the second insulating layer 32 and on a recipient on the second conductive layer 22. The second pattern is to link each second conductive layer 22 provided to two contact holes 35.

More specifically, the relative position of the nozzle 118 to the base substrate 1a is changed two dimensionally, i.e. in the X-axis and Y-axis directions. When the nozzle 118 reaches at a position corresponding to a pattern to be formed, the fifth discharge device 15A discharges droplets of a third conductive material 23A from the nozzle 118. The discharged droplets of the third conductive material 23A land on recipients on the second insulating layer 32 and the second conductive layer 22. As the droplets of the third conductive material 23A land on the recipients, the third conductive material layer 23B is provided on the recipients on the second insulating layer 32 and the second conductive layer 22.

After providing the third conductive material layer 23B, the third conductive material layer 23B is activated. For this purpose, the base substrate 1a is placed inside the fifth oven 15B in the present embodiment. By heating the third conductive material layer 23B, silver micro particles in the third conductive material layer 23B are sintered or welded. As a result of the activation, the third conductive layer 23 electrically coupled to each second conductive layer 22 provided to two contact holes 35 is provided as shown in FIG. 7B.

The third conductive layer 23 electrically couples the wirings 25A and 25C included in the first conductive layer 21. Meanwhile, the wiring 25B also included in the first conductive layer 21 is electrically isolated from both the wirings 25A and 25C.

F6. Third Insulating Layer

After providing the third conductive layer 23, a third insulating layer 33 that covers the third conductive layer 23 is provided.

First, the base substrate 1a is placed on the stage 106 included in the sixth discharge device 16A as shown in FIG. 7C. Consequently, the sixth discharge device 16A provides, based on sixth bitmap data, a third insulating material layer 33B that covers the third conductive layer 23.

More specifically, the relative position of the nozzle 118 to the base substrate 1a is changed two dimensionally, i.e. in the X-axis and Y-axis directions. When the nozzle 118 reaches at a position corresponding to a pattern to be formed, the sixth discharge device 16A discharges droplets of a third insulating material 33A from the nozzle 118. The discharged droplets of the third insulating material 33A land on recipients on the second insulating layer 32 and the third conductive layer 23. As the droplets of the third insulating material 33A land on the recipients, the third insulating material layer 33B is provided. In the present embodiment, the third insulating material 33A and the first insulating material 31A are identical.

After providing the third insulating material layer 33B, the third insulating material layer 33B is activated. For this purpose, the base substrate 1a is placed inside the sixth oven 16B in the present embodiment. By heating the third insulating material layer 33B, a polyimide precursor in the third insulating material layer 33B is polymerized to provide a polyimide layer. As a result of the activation, a third insulating layer 33 that covers the third conductive layer 23 is provided as shown in FIG. 7D.

As mentioned above, the present embodiment provides a wiring substrate having a three-dimensional wiring configuration by ink jetting.

In particular, even if a step is developed on a first level surface, the surface of the next (second) level can be flattened by discharging the first insulating material 31A whose concentration is comparatively low on the first level surface. Furthermore, the present embodiment provides the contact hole 35 having a clearly defined shape by discharging the second insulating material 32A whose concentration is higher than that of the first insulating material 31A on the second level surface. In other words, the present embodiment provides an insulating layer that is flat and provided with the contact hole 35 having a clearly defined shape by discharging a liquid material (insulating material). Moreover, since the first insulating layer 31 and the second insulating layer 32 are made of the same material, they have the same coefficient of linear expansion, which makes it hard to produce stress due to thermal expansion.

### Second Embodiment

A method for providing a layer according to a second embodiment of the invention is substantially the same as the method for providing a layer of the first embodiment, except for how to provide a second insulating layer. Therefore, only a step to provide the second insulating layer will be described below in order to prevent redundancy.

G. Second Insulating Layer

First, the first conductive layer 21 and the first insulating layer 31 are provided on the base substrate 1a by the method for providing a layer of the first embodiment. Then, a second insulating layer that covers the first conductive layer 21 and the first insulating layer 31 is provided.

Specifically, the second discharge device 12A and the third discharge device 13A form, based on their bitmap data, a second insulating material layer on recipients on the first conductive layer 21 and the first insulating layer 31. The second insulating material layer is activated in a later step to be a second insulating layer.

The second insulating material layer to be the second insulating layer consists of a layer boundary part and a layer inner part. The layer boundary part is an outermost portion in the second insulating material layer or the second insulating layer. The layer inner part is a portion surrounded by the layer boundary part. Note that if the layer boundary part defines the outer shape of a contact hole or via hole in the second insulating material layer, the layer boundary part is surrounded by the layer inner part. At any rate, the layer boundary part and the layer inner part are close to each other.

In the present embodiment, a recipient on the first conductive layer 21 or the first insulating layer 31 that corresponds to the layer boundary part is hereinafter also called “first part 41”. Also, a recipient on the first conductive layer 21 or the first insulating layer 31 that corresponds to the layer inner part is hereinafter also called “second part 42”. The first part 41 is an outermost portion in the recipient. The second part 42 is a portion surrounded by the first part 41. The first part 41 and the second part 42 are close to each other. While the first part 41 and the second part 42 are on surfaces on the same level (second level) in the present embodiment, the first part 41 and the second part 42 may be on surfaces on different levels.

G1. Layer Boundary Part (Discharge onto the First Part 41)

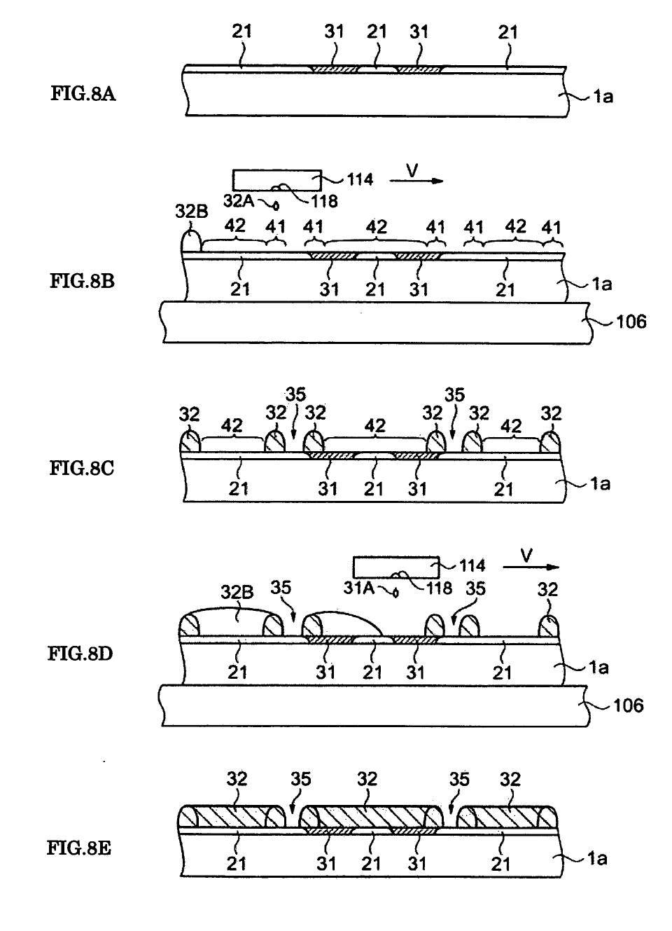

How to provide the second insulating layer will now be described in greater detail. As shown in FIG. 8B, the third discharge device 13A changes the relative position of the nozzle 118 (shown in FIG. 3) to the base substrate 1a in the Y-axis positive direction at a relative rate V. When the nozzle 118 reaches at a position corresponding to the first part 41, the head 114 discharges droplets of the second insulating material 32A.

By repeating the relative movement of the head 114 in the X-axis and Y-axis directions, the third discharge device 13A makes droplets of the second insulating material 32A land on the entire area of the first part 41 on the base substrate 1a. Accordingly, the second insulating material layer (layer boundary part) 32B that covers the first part 41 is provided.

The concentration of the second insulating material 32A is higher than that of the first insulating material 31A described in the first embodiment. Accordingly, it takes a shorter time for the second insulating material 32A that has landed on the first conductive layer 21 to lose its fluidity than for the first insulating material 31A to lose its fluidity. As a result, the second insulating material 32A is more suitable for defining the layer boundary part than the first insulating material 31A. This way the layer boundary part on the first part 14 can maintain an opening to be the contact hole 35 until the layer boundary part is activated and hardened, if the first part 41 is located correspondingly to the outer shape of the contact hole 35 as shown in FIGS. 8B and 8C, for example.

After providing the layer boundary part of the second insulating material layer 32B, the layer boundary part is activated. For this purpose, the base substrate 1a is placed inside the third oven 13B. By heating the base substrate 1a, the layer boundary part of the second insulating material layer 32B is hardened to provide a layer boundary part of the second insulating layer 32 as shown in FIG. 8C.

G2. Layer Inner Part (Discharge onto the Second Part 42)

After providing the layer boundary part of the second insulating layer 32, the layer inner part is provided. As shown in FIG. 8D, the second discharge device 12A changes the relative position of the nozzle 118 (shown in FIG. 3) to the base substrate 1a in the Y-axis positive direction at a relative rate V. When the nozzle 118 reaches at a position corresponding to the second part 42, the head 114 discharges droplets of the first insulating material 31A. As described in the first embodiment, the concentration of the first insulating material 31A is set sufficiently low. Therefore, the first insulating material 31A that has landed on the second part 42 spreads sufficiently broadly.

By repeating the relative movement of the head 114 in the X-axis and Y-axis directions, the second discharge device 12A fills the area (second part 42) surrounded by the layer boundary part with the first insulating material 31A. As a result, the second discharge device 12A provides the layer inner part of the second insulating material layer 32B.

After providing the layer inner part of the second insulating material layer 32B, the layer inner part of is activated. For this purpose, the base substrate 1a is placed inside the second oven 12B. By heating the base substrate 1a, the layer inner part of the second insulating material layer 32B is hardened to provide a layer inner part of the second insulating layer 32. Now that the layer boundary part of the second insulating layer 32 has been already provided, the activation with the second oven 12B completes the second insulating layer 32. Specifically, the second insulating layer 32 (polyimide layer) that covers the first conductive layer 21 and the first insulating layer 31 is provided as shown in FIG. 8E after the activation with the second oven 12B. Also as described above, the second insulating layer 32 has the contact hole 35 on each of the wirings 25A and 25C.

Thus, the second discharge device 12A and the third discharge device 13A can make the degree of spread of the liquid material 111 partly different on a substance, even if surface modification is uniformly provided on the substance.

The wiring substrates exemplified in the first and second embodiments are wiring substrates coupled to a liquid crystal panel included in a liquid crystal display. Thus, the methods according to the first and second embodiments are applicable to manufacturing of liquid crystal displays.

Furthermore, the methods according to the first and second embodiments are applicable to manufacturing not only of liquid crystal displays but also of various electro-optical devices. Here, the electro-optical devices are not limited to devices utilizing changes in optical characteristics (so-called electro-optical effects) such as changes in birefringence, optical rotatory power, or light scattering, and include all devices that emit, transmit, or reflect light in accordance with the application of a signal voltage.

Examples of such electro-optical devices include liquid crystal displays, electroluminescent displays, plasma displays, surface-conduction electron-emitter displays (SED), and field emission displays (FED).

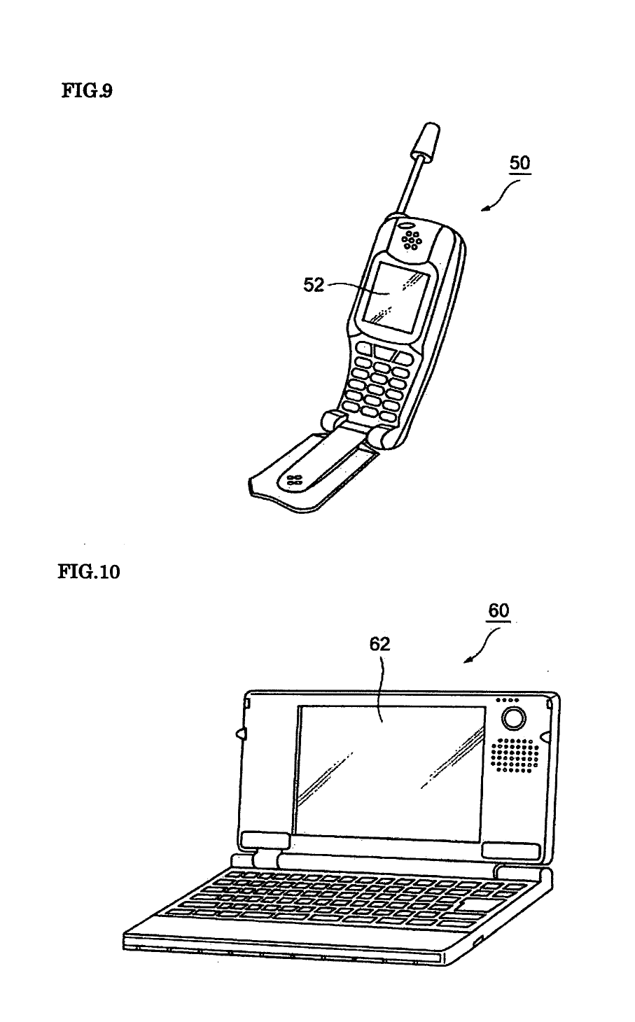

In addition, the methods according to the first and second embodiments are applicable to manufacturing of various electronic equipment. For example, the methods according to the first and second embodiments are applicable to manufacturing of a mobile phone 50 having a liquid crystal display 52 shown in FIG. 9 and of a personal computer 60 having a liquid crystal display 62 shown in FIG. 10.

First Modification

The first insulating layer 31 and the second insulating layer 32 according to the first and second embodiments are made of polyimide. Note that other polymer materials can also be used instead of polyimide. If the first insulating layer 31 and the second insulating layer 32 are made of other polymer materials, the first insulating material 31A and the second insulating material 32A may include a corresponding polymer precursor instead of the polyimide precursor.

Second Modification

The insulating layers made of the first insulating material 31A and the second insulating material 32A include polyimide having the same structure, that is, polymer materials having the same structure. Therefore, the structure of the polymer precursor contained in the first insulating material 31A is the same as that in the second insulating material 32A. However, the structure of the polymer precursor contained in the first insulating material 31A may differ from that in the second insulating material 32A, as long as they produce insulating layers having nearly equal coefficients of linear expansion. This is because the above-described effects are available only if the concentration of the first insulating material 31A is lower than that of the second insulating material 32A, even when the first insulating material 31A and the second insulating material 32A contain polymer precursors of different structures.

Third Modification

Metal wirings are provided on the base substrate 1a made of polyimide according to the first and second embodiments. Instead of this base substrate 1a, ceramics, glass, epoxy, glass epoxy, or silicon substrates may be used to achieve the same effects in the first and second embodiments. When a silicon substrate is used, a passivation film may be deposited on the surface of the substrate before the conductive materials are discharged. Even if any substrates or films are used, an area onto which the liquid material 111 lands from the nozzle 118 corresponds to the “recipient”.

Fourth Modification

While the conductive materials used in the first and second embodiments contain silver nanoparticles, nanoparticles of other metals may be used instead. Examples of such metals may include gold, platinum, copper, palladium, rhodium, osmium, ruthenium, iridium, iron, tin, zinc, cobalt, nickel, chromium, titan, tantalum, tungsten, and indium. Any one of or an alloy of two or more of these materials may be used. Note that using a conductive material containing silver nanoparticles is preferable for ink jetting, since silver is easy to handle with a comparatively low reduction temperature.

Also, the conductive materials may contain organic metal compounds instead of metal nanoparticles. Here, the organic metal compounds mean compounds with which metal is separated out through decomposition by heat (i.e. activation). Examples of such organic metal compounds may include chlorotriethylphosphine gold (I), chlorotrimethylphosphine gold (I), chlorotriphenylphosphine gold (I), silver (I) 2,4-pentanedionato complexes, trimethylphosphine (hexafluoroacetylacetonato) silver (I) complexes, and copper (I) hexafluoropentane dionato cyclooctadiene complexes.

This way metal contained in the conductive materials can be in the form of either particles such as nanoparticles or compounds such as organic metal compounds.

Fifth Modification

According to the first and second embodiments, the conductive and insulating material layers are activated by heat with the ovens 11B, 12B, 13B, 14B, 15B, and 16B. In addition to heating, the conductive or insulating material layers may be activated by irradiating the layers with light with ultraviolet- or visible-light-wavelengths, or electromagnetic waves such as microwaves. Instead of this activation, the conductive or insulating material layers may be simply dried. This is because leaving the conductive and insulating material layers that have been provided as they are can develop the conductive and insulating layers, respectively. Note that it takes a shorter time to make the conductive or insulating layers by means of some kind of activation than simply drying the conductive or insulating material layers. Therefore, the conductive or insulating layers are preferably activated.

Sixth Modification

While the first conductive layer is a silver wiring provided by ink jetting according to the first and second embodiments, the first conductive layer may be a copper wiring provided by photolithography.

Seventh Modification

According to the first and second embodiments, the first insulating material 31A is discharged from the second discharge device 12A, while the second insulating material 32A is discharged from the third discharge device 13A. However, the first insulating material 31A and the second insulating material 32A may be discharged not separately from the second discharge device 12A and the third discharge device 13A, but from a single discharge device. Also according to the first and second embodiments, polymer precursors contained in the first insulating material 31A and the second insulating material 32A are identical. Therefore, there is no need to clean a flow path such as the tank 101 and the tube 110 in switching the first insulating material 31A and the second insulating material 32A. Therefore, the number of discharge devices can be reduced without increasing a step for washing the flow path in the devices.

What is claimed is:

1. A method for providing a layer by ink jetting, comprising:
(a) discharging a first liquid insulating material of a first concentration on a surface of a first level so that a side of a first conductive layer placed on the surface is covered by the first insulating material;
(b) providing a first insulating layer facing the first conductive layer by one of activating and drying the first insulating material that has been discharged;
(c) discharging a second liquid insulating material of a second concentration on the first conductive layer and the first insulating layer, the second concentration being higher than the first concentration; and
(d) providing a second insulating layer covering the first conductive layer and the first insulating layer by one of activating and drying the second insulating material that has been discharged.

2. The method for providing a layer according to claim 1, the first conductive layer being a copper wiring.

3. The method for providing a layer according to claim 1, further comprising:
(e) discharging a first liquid conductive material on the surface; and
(f) providing the first conductive layer by one of activating and drying the first conductive material that has been discharged.

4. The method for providing a layer according to claim 3, (e) including discharging the first conductive material containing silver.

5. The method for providing a layer according to claim 1, (c) including discharging the second insulating material so that the second insulating material defines a contact hole that exposes part of the first conductive layer, and (d) including providing the second insulating layer having the contact hole by one of activating and drying the second insulating material that has been discharged.

6. The method for providing a layer according to claim 5, further comprising:
(g) providing a second conductive layer facing the first conductive layer in the contact hole.

7. The method for providing a layer according to claim 6, (g) including discharging a second liquid conductive material in the contact hole; and providing the second conductive layer by one of activating and drying the second conductive material that has been discharged.

8. A method for providing a layer that covers a first part and a second part facing the first part by ink jetting, comprising:
(a) discharging a first liquid insulating material of a first concentration on the first part; and
(b) discharging a second liquid insulating material of a second concentration on the second part after (a).

9. A wiring substrate manufactured by the method for providing a layer according to claim 1.

10. An electro-optical device manufactured by the method for providing a layer according to claim 1.

11. Electronic equipment manufactured by the method for providing a layer according to claim 1.
